(19) United States
(12) Patent Application Publication
(10) Pub. No.: US 2013/0160599 A1
(43) Pub. Date: Jun. 27, 2013

(54) CONTROL CABLE

(71) Applicant: Takaaki Hayashida, Nagoya (JP)

(72) Inventor: Takaaki Hayashida, Nagoya (JP)

(73) Assignee: CHUO HATSUJO KABUSHIKI KAISHA, Nagoya (JP)

(21) Appl. No.: 13/821,334

(22) PCT Filed: Jun. 21, 2011
(86) PCT No.: PCT/JP2011/064166

§ 371 Date: Mar. 7, 2013

(30) Foreign Application Priority Data
Sep. 7, 2010 (JP) 2010-200010

(51) Int. Cl. F16C 1/20; F16C 1/24

(52) U.S. Cl. CPC F16C 1/20; F16C 1/24
USPC 74/502.5

(57) ABSTRACT

A control cable which allows a shortened initial adaptation period is provided. A control cable 1 disclosed in the present specification includes an outer casing 2, an inner cable 3 slidably disposed within the outer casing 2, and grease disposed in a space 7 located between the outer casing 2 and the inner cable 3. A metal oxide is added to the grease. The metal oxide may be formed of a metal that is the same as a metal forming a metal coating that covers the inner cable.

### TECHNICAL FIELD

The present application relates to a control cable that is preferably usable for a vehicle (for example, an automobile, a motorcycle, and an industrial vehicle such as a forklift truck).

### BACKGROUND ART

A control cable includes an outer casing and an inner cable disposed within the outer casing. When an operator operates the inner cable, the inner cable slides relative to the outer casing. If there is a great sliding friction of the inner cable and the outer casing, a loading efficiency of the control cable is reduced, and an operation feeling is deteriorated. Therefore, in order to reduce a sliding friction of the inner cable and the outer casing, a control cable in which grease is disposed between the inner cable and the outer cable has been developed (for example, Patent Application Publication No. 2003-21130).

### SUMMARY OF INVENTION

### Technical Problem

In a control cable, normally, the loading efficiency is low in an initial period following a start of use of the control cable, increases as the number of times that the control cable is used increases, and then, becomes in a steady state. In an existing control cable, a period until its loading efficiency reaches a steady state (i.e., a so-called initial adaptation period) is long, and a bad feeling might be given to a user during the initial adaptation period. For example, for a control cable for a manual transmission of an automobile, the loading efficiency affects a shift feeling that a user has, and thus, is an important factor in evaluating the automobile. In general, when a consumer purchases an automobile, the consumer drives a test car at an automobile distributor and evaluates the test car. In many cases, such a test car is brand new, and a control cable used for a manual transmission is in an initial adaptation period. Thus, it is highly likely that a consumer who test-drives a test car uses a control cable in an initial adaptation period, and therefore, the consumer might not be able to have a comfortable shift feeling.

An object of the present application is to provide a control cable which allows reduction in initial adaptation period.

### Solution to Technical Problem

A control cable disclosed in the present description includes an outer casing, an inner cable slidably disposed within the outer casing, and grease disposed between the outer casing and the inner cable. A metal oxide is added to the grease.

In the control cable, the metal oxide is added to the grease provided between the outer casing and the inner cable. As a result of keen examinations conducted by the present inventor, the inventor found that, with the metal oxide added to the grease, the initial adaptation period of the control cable may be drastically shortened. Therefore, for the control cable, as compared to an existing control cable, the initial adaptation period may be drastically shortened.

In the above-described control cable, a metal coating may be formed on a surface of the inner cable. In this case, a metal forming the metal coating is preferably the same as a metal forming the metal oxide added to the grease. Moreover, in the control cable, the inner cable may include a single wire or a plurality of wires. In this case, the metal oxide added to the grease is preferably softer than a material of the wire of the inner cable. Also, the metal oxide added to the grease may be selected from the group consisting of ZnO, Al₂O₃, MgO, and CaO.

### BRIEF DESCRIPTION OF DRAWINGS

FIG. 1 is a partially broken schematic view illustrating a control cable according to an embodiment;

FIG. 2 is a cross-sectional view taken along the wire II-II of FIG. 1;

FIG. 3 is a graph illustrating measurement results for the relationship between the number of operations (the endurable number of times) and load efficiency;

FIG. 4 is a graph illustrating measurement results for the relationship between an additive amount of metal oxide and load efficiency; and

FIG. 5 is a graph illustrating measurement results for the relationship between the number of operations (the endurable number of times) and load efficiency.

### DESCRIPTION OF EMBODIMENTS

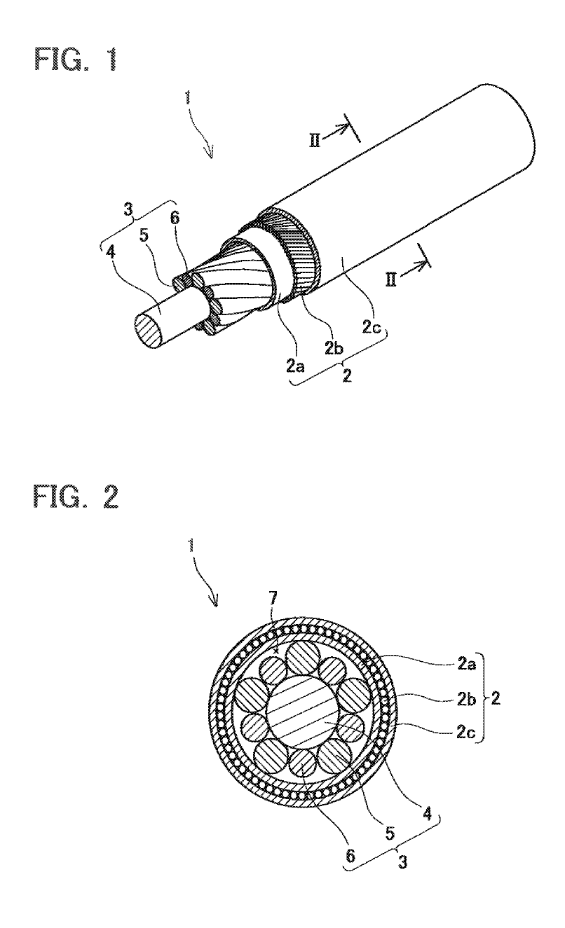

A control cable according to an embodiment will be described. As illustrated in FIG. 1 and FIG. 2, a control cable 1 includes an inner cable 3 and an outer casing 2 within which the inner cable 3 is slidably disposed.

The inner cable 3 may comprise a core wire 4, a plurality of main auxiliary wires 5 [five main auxiliary wires 5 in total (in pentagonal twist) in FIG. 2] wound in a helical fashion around the core wire 4, a plurality of sub auxiliary wires 6 [five sub auxiliary wires 6 in total (in pentagonal twist) in FIG. 2] each of which is interposed between associated adjacent ones of the main auxiliary wires 5 and which are wound in a helical fashion around the core wire 4 in a similar manner to the main auxiliary wires 5. The core wire 4 is a single steel wire. As a material of the core wire 4, for example, a hard steel wire, a stainless wire, an oil tempered wire (SWO-A (Japanese Industrial Standard JIS G 3560), SWO-B (JIS G 3560), SWOSC-V (JIS G 3566)), and a bluing wire, etc. may be used. A surface processing layer of various types may be formed on a surface of the core wire 4. For example, for the purpose of preventing rusting and the like, zinc plating may be performed on the surface of the core wire 4. Also, for the purpose of improving a sliding property, fluorine treatment may be performed on the surface of the core wire 4. Each of the number of the main auxiliary wires 5 and the number of the sub auxiliary wires 6 may be any number other than five (i.e., for example, seven). In view of increasing the load efficiency, it is preferable that each of the number of the main auxiliary wires 5 and the number of the sub auxiliary wires 6 is an odd number. For the main auxiliary wires 5 and the sub auxiliary wires 6, the same material as the material of the core wire 4 may be used. A similar surface treatment (for example, zinc plating) to the treatment performed to the core wire 4 may be performed also on surfaces of the main auxiliary wires 5 and the sub auxiliary wires 6.

Note that the inner cable may be formed to have various well-known structures other than the above-described structure, and other than a push-pull type inner cable that transmits push and pull, a pull type inner cable that transmits only a pull may be employed. For example, a single wire structure consisting of a single steel wire, and a twist wire structure with no core wire (for example, a twist wire formed of a plurality of steel wires twisted) may be used.

The outer casing 2 may be formed to have a three-layer structure in which an innermost layer thereof may be formed of a resin liner 2a, an intermediate layer thereof may be formed of a strands 2b formed of a number of steel wires, and an outermost layer may be formed of an outer coat 2c. The liner 2a is formed of a resin composition, which will be described layer, in a tubular shape. The strands 2b may be formed of a number of steel wires twisted in a helical fashion around liner 2a with no space between adjacent ones of the steel wires. For the strands 2b, not only steel wires each having a circular cross-section but also flat steel wires each having a rectangular cross-section may be used. The outer coat 2c that covers an outer periphery of the strands 2b may be formed of polypropylene, polyethylene, or polyamide, etc.

The resin composition forming the liner 2a may contain polybutylene terephthalate (PBT), polyethylene (PE), and acrylonitrile styrene (AS). Polybutylene terephthalate (PBT) is synthesized by polycondensating terephthalic acid (TPA) or dimethyl terephthalate (DMT) and 1,4-butanediol. Polyethylene (PE) is a polymer having a structure of polymerized ethylene. For a material of the liner 2a, high density polyethylene (HDPE), low density polyethylene (LDPE), and ultrahigh molecular weight polyethylene (UHMW-PE), etc. may be used. Acrylonitrile styrene (AS) is a copolymer of styrene and acrylonitrile. Note that, when the resin composition of the liner 2a is generated, a material in which polyethylene (PE) and acrylonitrile styrene (AS) are copolymerized in advance may be used.

Note that the resin composition forming the liner 2a does not have to contain all of polybutylene terephthalate (PBT), polyethylene (PE), and acrylonitrile styrene (AS). Also, the liner 2a may be formed of any one of polyethylene (PE), polytetrafluoroethylene (PTFE), polybutylene terephthalate (PBT) and polyacetal (POM), or a resin made of a combination of the materials listed above. Also, a regular additive such as an antioxidant, a thermostabilizer, a lubricant, a crystal nucleator, an ultraviolet rays protective agent, a colorant, and a flame retardant, etc., and a small amount of another polymer may be added to the resin composition of the liner 2a. Moreover, the above-described resin composition may be formed into a tubular shaped liner 2a using a well-known method.

A grease (not illustrated) is provided in a space 7 located between the outer casing 2 and the inner cable 3. The grease may contain lubricant base oil and a thickener. As the lubricating base oil, any one of a silicon-based lubricant, a fluorine-based lubricant, a mineral-based lubricant, and a hydrocarbon-based lubricant, or a mixture of the foregoing may be used. When a silicon-based lubricant or a fluorine-based lubricant is used as the lubricant base oil, excellent high-temperature properties may be achieved. For the thickener, various thickeners, such as generally used organic, inorganic, and urea-based thickeners may be used. For example, an Na soap or an Li soap may be used.

The grease of this embodiment contains a metal oxide as an additive. By adding the metal oxide to the grease, an initial adaptation period for the control cable 1 may be drastically shortened. An additive amount of the metal oxide to be added is preferably 1 to 20% by weight relative to the grease (i.e., an amount of the lubricant base oil and the thickener). This is because, if the additive amount is less than 1% by weight, an advantage of shortening the initial adaptation period is small. On the other hand, if the additive amount is more than 20% by weight, a viscosity of the grease becomes too large. As for a grain diameter of the metal oxide, an average grain diameter is preferably 0.1 to 10 μm. A reason for this is that, if the average grain diameter is less than 0.1 μm, aggregation is caused by an intermolecular energy and the metal oxide cannot be uniformly dispersed in the grease. On the other hand, if the average grain diameter is more than 10 μm, a friction generated when the inner cable 3 slides is increased.

As the metal oxide added to the grease, a metal oxide which is softer than a material of the core wire 4 and/or the side wires 5 and 6 of the inner cable 3 is preferably used. Therefore, it is preferable that, when a hard steel wire is used for the core wire 4 and/or the side wires 5 and 6, a metal oxide which is softer than the hard steel wire (Fe) is used. Specifically, any one selected from the group consisting of ZnO, Al₂O₃, MgO, and CaO may be used as the additive. By using the above-described metal oxide as an additive, the sliding friction for the inner cable 3 may be reduced, and the loading efficiency may be increased. Also, it is preferable that, when a metal coating is formed on surfaces of the core wire 4 and/or the side wires 5 and 6 of the inner cable 3, a metal forming the metal oxide added to the grease is the same as a metal forming the metal coating. For example, when zinc plating is performed on the surfaces of the core wire 4 and/or the side wires 5 and 6, zinc oxide (ZnO) is preferably used as the metal oxide. By adding as an additive the same metal as the metal forming the metal coating, the adaptability of the grease and the inner cable may be increased and the initial adaptation period may be effectively shortened.

Note that, in addition to the above-described metal oxide, some other additive may be added to the grease. That is, a well-known additive such as an antioxidant, a rust preventive agent, an extreme pressure agent, a friction preventive agent, a corrosion inhibitor, a thickening agent, and a solid lubricant, etc. may be added. For example, polytetrafluoroethylene (PTFE), may be used as a sliding additive. Polytetrafluoroethylene (PTFE) is excellent in heat resistance and oxidative stability, and functions as a solid lubricant that is excellent in chemical resistance. As a method for disposing the grease in the space 7 located between the outer casing 2 and the inner cable 3, various methods may be used. For example, by applying the grease to an inner surface of the liner 2a, the grease may be disposed in the space 7. Alternatively, by applying the grease to an outer surface of the inner cable 3, the grease may be disposed in the space 7.

### EXAMPLE 1

As Example 1, a control cable for a transmission of an automobile was formed. As illustrated in FIG. 1 and FIG. 2, an inner cable 3 was formed of a core wire 4, five main auxiliary wires 5, and five sub auxiliary wires 6. Steel wires were used for the core wire 4, the main auxiliary wires 5, and the sub auxiliary wires 6, and zinc plating was performed on their surfaces. An outer casing 2 was formed of a liner 2a, strands 2b, and an outer coat 2c. The liner 2a was formed of polybutylene terephthalate (PBT). Steel wires each having a circular cross-section were used for the strands 2b. The outer coat 2c was formed of polypropylene. For grease, a silicon-based lubricant was used as lubricant base oil, Na soap was used as a thickener, and polytetrafluoroethylene (PTFE) and zinc oxide (ZnO) were added as additives. Polytetrafluoroethylene (PTFE), in terms of the ratio by weight, in amount of 20% by weight relative to a mixture of the lubricant base oil and the thickener was added. Additives (zinc oxide (ZnO)) in three different amounts in terms of the ratio by weight, i.e., in amount of 1% by weight, the additive in amount of 5% by weight, and the additive in amount of 10% by weight relative to the mixture of the lubricant base oil and the thickener were added, thereby forming three types of control cables. Note that, as Comparative Example 1, a control cable to which the additive (zinc oxide (ZnO)) was not added was formed. Other than that, a structure of the control cable of Comparative Example 1 was the same as a structure of the control cable of Example 1.

As Example 2, a control cable in which a liner 2a was formed of a different material from that in Example 1 was provided. That is, the liner 2a of Example 2 was formed of a resin composition obtained by adding a copolymer, obtained by copolymerizing polyethylene (PE) and acrylonitrile styrene (AS) at a ratio by weight of 50/50, in amount of 5% by weight to polybutylene terephthalate (PBT) and then purifying a resultant. Other than that, a structure of the control cable of Example 2 was the same as the structure of the control cable of Example 1. However, an amount of an additive (zinc oxide (ZnO)) added to grease was 5% by weight only. As Comparative Example 2, a control cable having the same structure as the structure of the control cable of Example 2 in which an additive (zinc oxide (ZnO)) was not added to grease was formed. As Example 3, a control cable in which a sliding additive (polytetrafluoroethylene (PTFE)) was not contained in grease was formed. Other than that, a structure of the control cable of Example 3 was the same as the structure of the control cable of Example 2. Data for each of the control cables will be collectively given in Table 1.

TABLE 1

| | Liner | Sliding Additive | Additive (ZnO) | |
|---|---|---|---|---|
| Example 1 | PBT | 20% by weight | 1, 5 and 10% | by weight |
| Example 2 | PBT + PE + | 20% by weight | 5% | by weight |
| | AS | | | |
| Example 3 | PBT + PE + | 0% by weight | 5% | by weight |
| | AS | | | |
| Comparative | PBT | 20% by weight | 0% | by weight |
| Example 1 | | | | |
| Comparative | PBT + PE + | 20% by weight | 0% | by weight |
| Example 2 | AS | | | |

Next, each of the formed control cables was bent and routed, and a loading efficiency thereof was measured. In measurement, a weight was attached to one end of each inner cable, the other end of the inner cable was moved back and forth with a stroke of 100 mm at a speed of 30 times per minute, and a load needed for operating the other end of the inner cable was measured. On the basis of the measured load and the weight attached to the one end of the inner cable, the loading efficiency (i.e., the weight/the measured load) was calculated.

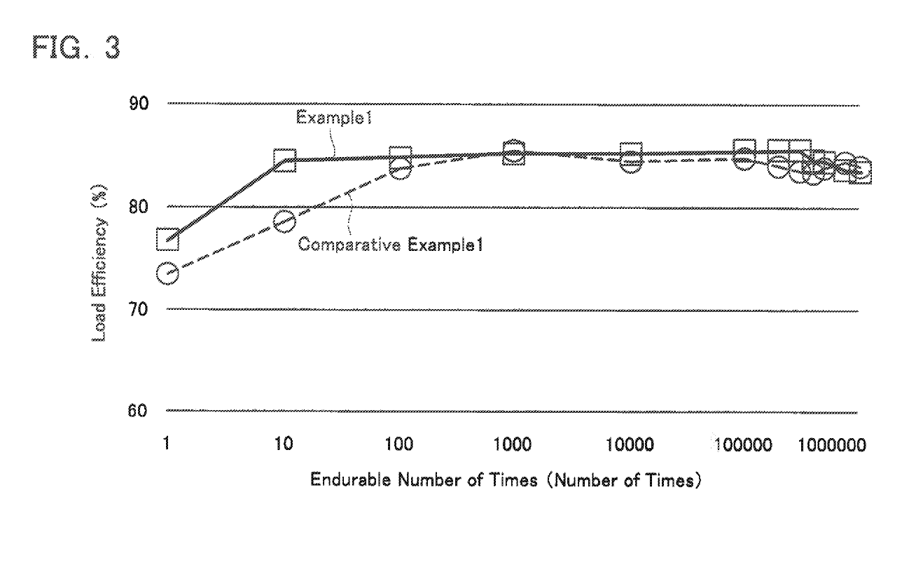

FIG. 3 illustrates measurement results for the control cable in which the additive (ZnO) in amount of 5% by weight was added to the grease among the control cables of Example 1, and measurement results for the control cable of Comparative Example 1. As illustrated in FIG. 3, the initial adaptation period was approximately 10 times in the control cable of Example 1, while the initial adaptation period was approximately 100 times in the control cable of Comparative Example 1. That is, in the control cable of Example 1, the initial adaptation period was approximately 1/10 of the control cable of the comparative example (the related art). Moreover, similar to the control cable of Comparative Example 1, the control cable of Example 1 exhibited an excellent loading efficiency even when the number of operations reached one million times.

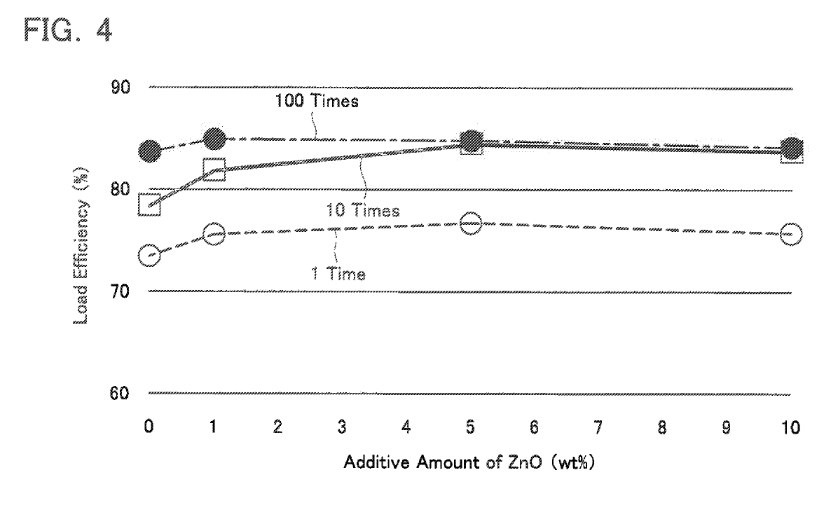

FIG. 4 illustrates measurement results for the three types of control cables of Example 1 and measurement results for the control cable of Comparative Example 1. In FIG. 4, the dashed line represents the loading efficiency when the number of operations was 1, the solid line represents the loading efficiency when the number of operations was 10, and the alternate long and short dash line represents the loading efficiency when the number of operations was 100. As illustrated in FIG. 4, in the control cables in which the additive amount of the additive (ZnO) was 5% by weight and 10% by weight, the loading efficiency when the number of operations was 10 and the loading efficiency when the number of operations was 100 were approximately the same (i.e., the initial adaptation period was 10 or less). On the other hand, in the control cable in which the additive amount of the additive (ZnO) was 1% by weight, the loading efficiency when the number of operations was 10 was slightly smaller than the loading efficiency when the number of operations was 100 (i.e., the initial adaptation period was larger than 10). However, a difference between the loading efficiency when the number of operations was 10 and the loading efficiency when the number of operations was 100 was small, and the initial adaptation period was obviously smaller than that of Comparative Example 1 (in which the additive (ZnO) was not added).

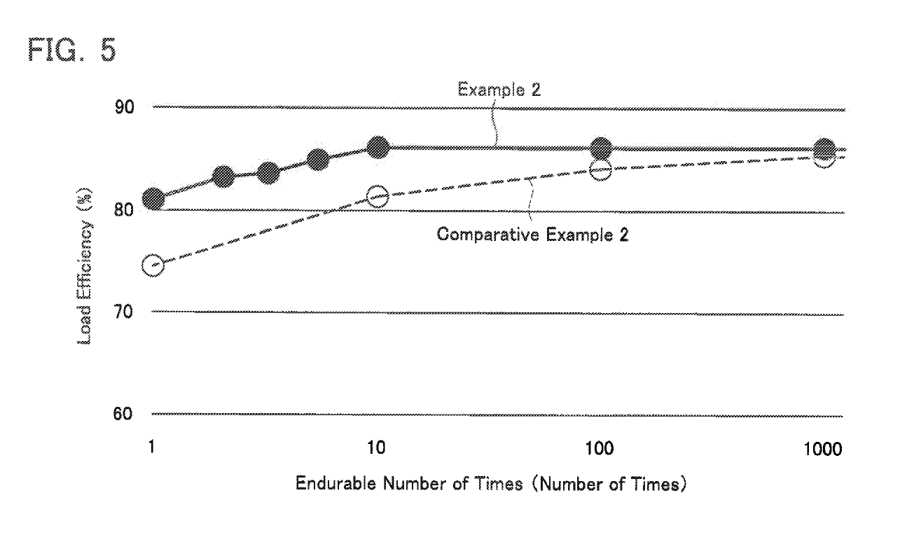

FIG. 5 illustrates measurement results for the control cable of Example 2 and measurement results for the control cable of Comparative Example 2. As clearly understood from FIG. 5, the control cable of Example 2 had a high loading efficiency from a time when the number of operations was 1, and a difference between the loading efficiency in the initial adaptation period and the loading efficiency in a steady state was very small. On the other hand, in the control cable of Comparative Example 2, similar to Comparative Example 1, the initial adaptation period was approximately 100.

TABLE 2

| | Number of Operations | | |
|---|---|---|---|
| | 1 | 10 | 100 |
| Example 2 | 81.0% | 87.0% | 87.5% |
| Example 3 | 78.0% | 82.5% | 83.0% |
| Comparative Example 2 | 73.5% | 81.0% | 83.5% |

Table 2 illustrates measurement results (the loading efficiency) for the control cables of Example 2, Example 3, and Comparative Example 2. As understood from comparison between Example 2 and Example 3, in the control cable in which the sliding additive (polytetrafluoroethylene (PTFE)) was not added to the grease, the loading efficiency dropped, as compared to the control cable in which the sliding additive (polytetrafluoroethylene (PTFE)) was added to the grease. However, for the initial adaptation period, regardless of whether or not the sliding additive (PTFE) was added to the grease, excellent results were obtained.

As described above, in the control cables of Examples 1 to 3, by adding zinc oxide (ZnO) to the grease, the initial adaptation period was drastically shortened. Also, even when zinc oxide (ZnO) was added to the grease, similar to a control cable of the related art, the loading efficiency was maintained high for a long period.

Note that, although each of the above-described examples relates to a control cable for a transmission of an automobile, a control cable according to the present application may be used for some other application (for example, a pull cable such as a parking cable, and an opener cable, etc.)

While the control cables of the present embodiment have been described above in detail, these examples are merely illustrative and place no limitation on the scope of the patent claims. The technology described in the patent claims also encompasses various changes and modifications to the specific examples described above.

The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

1. A control cable, comprising:
an outer casing;
an inner cable slidably disposed within the outer casing, and
grease disposed between the outer casing and the inner cable, wherein
a metal oxide is added to the grease.

2. The control cable according to claim 1, wherein a metal coating is formed on a surface of the inner cable, and a metal forming the metal coating is same as a metal forming the metal oxide added to the grease.

3. The control cable according to claim 2, wherein the inner cable comprises a single or a plurality of wires, and the metal oxide added to the grease is softer than a material of the wire of the inner cable.

4. The control cable according to claim 3, wherein the metal oxide added to the grease is selected from the group consisting of ZnO, Al₂O₃, MgO, and CaO.

5. The control cable according to claim 1, wherein the inner cable comprises a single or a plurality of wires, and the metal oxide added to the grease is softer than a material of the wire of the inner cable.

6. The control cable according to claim 5, wherein the metal oxide added to the grease is selected from the group consisting of ZnO, Al₂O₃, MgO, and CaO.

7. The control cable according to claim 1, wherein the metal oxide added to the grease is selected from the group consisting of ZnO, Al₂O₃, MgO, and CaO.
